(19) United States
(12) Patent Application Publication
(10) Pub. No.: US 2007/0150717 A1
(43) Pub. Date: Jun. 28, 2007

(54) SELECTABLE BOOTING METHOD BY BIOS WITH MULTI-PARTITION IN THE DISK ON A SINGLE COMPUTER PLATFORM

(75) Inventor: Hung-Ping Chen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: MITAC TECHNOLOGY CORP., Hsin-Chu Hsien (TW)

(21) Appl. No.: 11/682,878

(22) Filed: Mar. 7, 2007

Related U.S. Application Data
(63) Continuation-in-part of application No. 10/605,916, filed on Nov. 6, 2003.

(30) Foreign Application Priority Data
Jul. 18, 2003 (TW) 92119648

(51) Int. Cl. G06F 9/00

(52) U.S. Cl. 713/2

(57) ABSTRACT

A selectable booting operation method by Basic Input Output System (BIOS) with multi-partitioned disk is provided in the present invention. The INT 19H interrupt service program in the original BIOS are slightly modified, so that when power is on the multi-partition boot selection flag being setup serves to select from the operating systems stored in different partitions of the disk, and booting time of the system is reduced accordingly. Therefore, with the present invention, users are free to choose one of the different operating systems on a single computer platform under different booting conditions upon preference without additional installation of the Boot Management Utility (BMU). Accordingly, the present invention eliminates the synchronization process that is originally performed on BMU if the operating system is being reinstalled or repeatedly installed, so as to avoid inconvenience and annoyance thereby.

### CROSS-REFERENCE TO RELATED APPLICATION

This application is a continuation-in-part of a prior application Ser. No. 10/605,916, filed Nov. 6, 2003, which claims the priority benefit of Taiwan application serial no. 92119648, filed on Jul. 18, 2003. All disclosures are incorporated herewith by reference.

### BACKGROUND OF THE INVENTION

1. Field of the Invention

The present invention relates to a Basic Input Output System (BIOS) booting procedure, and more particularly, to a selectable booting operation method by the BIOS with multi-partitioned disk.

2. Description of the Related Art

Making a comprehensive survey of the current computer systems for those compatible to IBM PC architecture, booting is usually operated by the Basic Input Output System (BIOS) by reading data blocks of head 0, cylinder 0, and sector 1 of the disk, (the three data blocks are also known as Master Boot Record, MBR,) into memory with the INT 19H interrupt service program. When reading the memory, the system controllability is transferred from BIOS to MBR code on the MBR. Then, the MBR code searches a single partition that has been set as bootable according to the disk partition table stored in the MBR data block. When the bootable partition is found, the boot sector of the partition is copied to the memory, thus the system controllability is transferred from the MBR code to the boot sector code. Finally, the system controllability is transferred from the boot sector code to the Operating System (OS) to complete the operation of booting the disk.

For further understanding, referring to FIG. 1 that illustrates a conventional BIOS booting procedure in a schematic flow chart format. As shown in FIG. 1 herein, the power is turned on (step S102), and the hardware in the computer is initialized (step S104). Then the TNT 19H interrupt service program is executed (step S106), and the MBR is read (step S108). Further, a single bootable partition in the disk is searched (step S110). When a single bootable partition in the disk is found, the boot sector of the bootable partition is read (step S112), and the OS stored in the boot sector is subsequently executed to boot the computer (step S114). If the single bootable partition is not found in the disk, a boot fail message is then displayed (step S116).

According to the foregoing description, there is merely a single partition of a single disk available for booting under this single computer platform environment, which lacks of flexibility. Being opted for choices of OS's on single computer platform, it is required to install a Boot Management Utility so as to perform selectable function as expected. Moreover, the current BIOS booting procedure fails to provide instant OS options at power-on. Therefore, the current BIOS booting procedure fails to provide miscellaneous OS's that are installed in multi partitions of the disk upon user's preferences or purposes.

### SUMMARY OF THE INVENTION

In the light of the above problems, the present invention provides a selectable booting operation method by the BIOS with the multi-partition in the disk. In the present invention, the INT 19H Interrupt Service Program in the original BIOS is slightly modified so as to select one of the operating systems that are stored in difference partitions via multi-partition boot selection flag, as well as to reduce boot time as power is turned on. The present invention further provides optimized and refined operation in advance so as to correspond to different operating systems as booting up a computer.

In order to achieve the above objects and others, the present invention provides a selectable booting operation method by the BIOS with multi-partition, wherein the disk comprises a plurality of partitions. In the operation method, the computer power is firstly turned on. A multi-partition boot selection flag is set and a plurality of hardware components in the computer is initialized. Then, an interrupt service program is executed, and the MBR in the disk is read out. The multi-partition boot selection flag is used for selecting one of the partitions, so as to determine whether the selected partition is a bootable partition or not. If a bootable partition is found, the boot sector therein is read and the computer is booted accordingly.

In one the embodiment of the present invention, setting the multi-partition boot selection flag is performed by pressing a button which is controlled by an embedded controller or an keyboard controller in a computer.

In one embodiment of the present invention, setting the multi-partition boot selection flag is performed by the remote controller.

In one embodiment of the present invention, the multi-partition boot selection flag is stored in a memory inside a computer.

In one embodiment of the present invention, the multi-partition boot selection flag is stored in a register inside a computer.

In one embodiment of the present invention, provided one of the partitions is not a bootable partition, a boot fail is indicated.

In one embodiment of the present invention, provided none of the multi partitions is a bootable partition, a default partition assigned by BIOS is thus read from the disk. Wherein provided the default partition is found bootable, the boot sector therein is thus read and booting is thus executed, whereas provided the default partition is not found bootable, a boot fail is indicated thereby.

In one embodiment of the present invention, an interrupt service program is INT 19H interrupt service program.

In summary, the present invention slightly modifies the procedure steps of the INT 19H interrupt service program in the original BIOS, such that as the power is turned on, the multi-partition boot selection flag is setup so as to select the operating systems stored in different partitions of the disk, thus booting time of the system is reduced. Therefore, with the present invention, users manages to choose from different operating systems under different booting conditions on a single computer platform based on user's preference without additional installation of boot management utility. Accordingly, the present invention eliminates synchronization process that is originally performed on BMU as reinstallation or repeated installation of the operating system is required, so as to avoid inconvenience and annoyance thereby.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 is a schematic flowchart illustrating conventional BIOS booting procedure according to prior art.

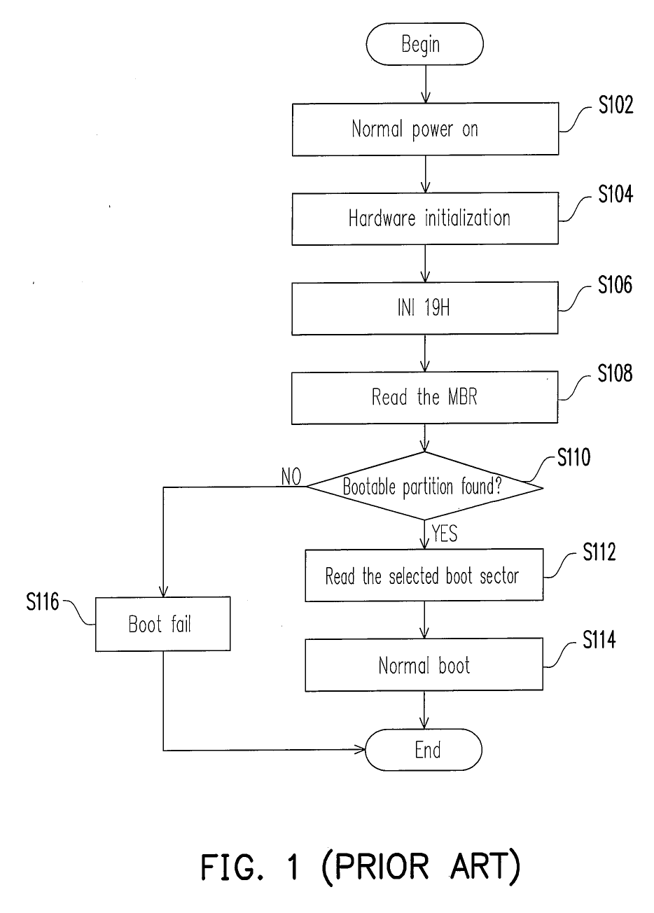

FIG. 2 is a schematic flowchart illustrating a selectable booting operation method by the BIOS with the multi-partition in the disk in one preferred embodiment of this present invention.

FIG. 3 is a schematic flowchart illustrating another selectable booting operation method by the BIOS with the multi-partition in the disk in another preferred embodiment of this present invention.

### DESCRIPTION OF THE PREFERRED EMBODIMENTS

The major concept of the present invention is to modify the original booting procedure, so as to provide different operating systems for user's choice. When user boots the system and activates different operating systems, the boot sector of the partition belongs to the selected operating system in the disk is read out. The operating system stored in different partition of the disk sets the partition to be booted up as a bootable partition according to the result of boot selection, and the MBR code then reads the boot sector in the corresponding partition to complete the boot procedure and steps. Therefore, the present invention achieves the object of selecting multiple operating systems in the multi-partition of the disk.

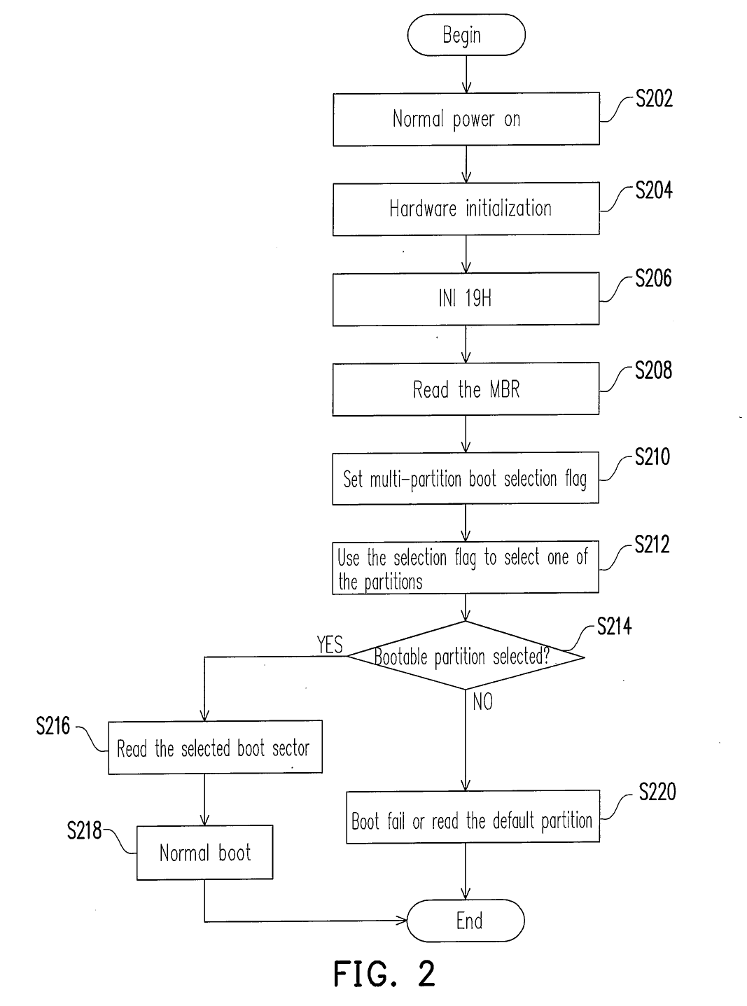

Referring to FIG. 2, it is a schematic flow chart illustrating a selectable booting operation method by the BIOS with the multi-partition in the disk, wherein the disk comprises a plurality of partitions. In the operation method, at first, the power of the computer is turned on (step S202), and a plurality of hardware components in the computer is initialized (step S204). Then, an interrupt service program (e.g. INT 19H interrupt service program) is executed, and the MBR in the disk is read out (step S208). Meanwhile, the system control right is transferred from the BIOS to the MBR code inside the MBR. Then, a multi-partition boot selection flag is set (step S210), which is then used to select one of the partitions (step S212). Selecting the multi-partition boot selection flag may be achieved by various methods. For example, the button controlled by the embedded controller or the keyboard controller may serve to set and select the multi-partition boot selection flag, so as to select one of the partitions in the disk. Further, the remote controller manages to set and select the multi-partition boot selection flag therein. For example, an external infrared remote controller may serve to select the multi-partition boot selection flag, so as to select one of the partitions in the disk. In addition, setting and selecting the multi-partition boot selection flag may be achieved based on the design upon customer/user's request. Moreover, the multi-partition boot selection flag is stored in the memory or register in the computer.

It is then diagnosed whether the partition is a bootable partition or not (step S214). If it is diagnosed that this partition is a bootable partition, the boot sector in this partition is read (step S216). Meanwhile, the system control right is transferred from the MBR code to the boot sector code in the boot sector. Finally, the boot sector code executes an operation of activating the operating system installed in the partition so as to boot up the computer (step S218). If it is determined that this partition is not a bootable partition, either a boot failed message is displayed or a default partition preset in the disk by the BIOS is read (step S220). If the default partition IS a bootable partition, the boot sector in the default partition is read for booting the computer, whereas if the default partition is not a bootable partition, a boot fail message is displayed.

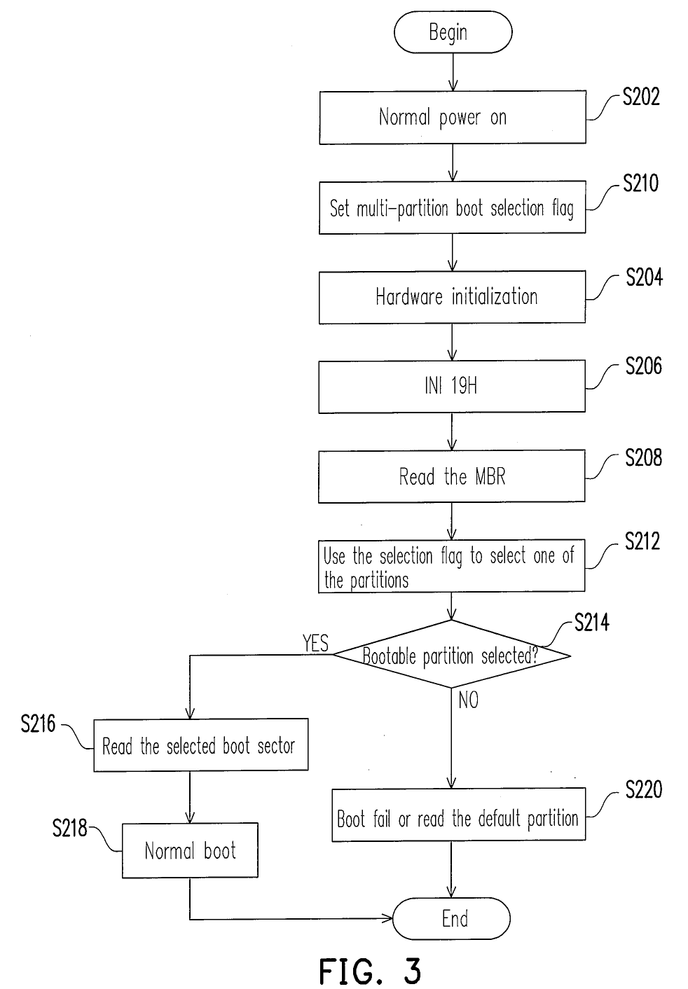

Now please refer to FIG. 3. FIG. 3 is a schematic flowchart illustrating another selectable booting operation method by the BIOS with the multi-partition in the disk in another preferred embodiment of this present invention. This embodiment is a modification of the previous one. One difference between this embodiment and the previous one is that, in FIG. 3, step S210 is executed between steps S202 and S204. First, the computer is turned on (step S202). The multi-partition boot selection flag is set (step S210). The hardware is initiated (step S204). The interrupt service program is executed (step S206). The MBR is read (step S208), and then the boot partition is selected by using the boot selection flag (step S212). The following steps S214-S220 are the same as those in FIG. 2, so they are not repeatedly discussed here. In FIG. 3, the boot selection flag is set after the computer is turn on and before the MBR is read, and the boot selection flag is set automatically without user intervention. This embodiment does not need to display an inquiry window to prompt the user to select a boot partition. Such an inquiry window is usually used by conventional boot management utilities and usually stalls the booting process. Therefore in this embodiment there is no inquiry window to stall the booting process. The selection of OS and the consequent booting can be carried out automatically, smoothly and continuously.

From descriptions above, the present invention provides added values and effects without using complicated steps and procedures. The present invention achieves the object of selectable booting the system by the BIOS with the multi-partition in the disk by determining the suitable booting condition to boot the corresponding operating system sector in the normal BIOS booting steps.

In summary, the present invention slightly modifies the procedure steps of the INT 19H interrupt service program in the original BIOS, such that when the power is turned on, a multi-partition boot selection flag is setup and thus serves to select the operating system stored in different partition of the disk, so as to reduce time consumption in booting the system. Therefore, by using the present invention, when the single computer platform is booting, users can start different operating system under different booting conditions based on their preference without having to additionally install the boot management utility. Accordingly, the present invention eliminates the synchronization process originally performed on the boot management utility when the operating system is being reinstalled or repeatedly installed, so as to avoid the inconvenience and troublesome thereof. In addition, the present invention also performs the corresponding optimization operation when booting up the computer in advance based on different requirements of the operating system.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A selectable booting operation method by a Basic Input Output System (BIOS) with a multi-partition in a disk which comprising a plurality of partitions, comprising:
turning on a power of a computer;
setting a multi-partition boot selection flag;
initializing a plurality of hardware components in the computer;
executing an interrupt service program;
reading a Master Boot Record (MBR) in the disk;
selecting one of the partitions by using the multi-partition boot selection flag;
determining whether the one of the partitions is bootable or not; and
reading a boot sector in the one of the partitions to boot the computer if the one of the partitions is determined bootable.

2. The selectable booting operation method by the BIOS with the multi-partition in the disk of claim 1, wherein setting the multi-partition boot selection flag is performed by pressing a button which is controlled by an embedded controller in the computer.

3. The selectable booting operation method by the BIOS with the multi-partition in the disk of claim 1, wherein setting the multi-partition boot selection flag is performed by pressing a button which is controlled by a keyboard controller in the computer.

4. The selectable booting operation method by the BIOS with the multi-partition in the disk of claim 1, wherein setting the multi-partition boot selection flag is performed by a remote controller.

5. The selectable booting operation method by the BIOS with the multi-partition in the disk of claim 1, wherein the multi-partition boot selection flag is stored in a memory in the computer.

6. The selectable booting operation method by the BIOS with the multi-partition in the disk of claim 1, wherein the multi-partition boot selection flag is stored in a register in the computer.

7. The selectable booting operation method by the BIOS with the multi-partition in the disk of claim 1, wherein when the one of the partitions is not bootable, a boot fail message is displayed.

8. The selectable booting operation method by the BIOS with the multi-partition in the disk of claim 1, wherein when the one of the partitions is not bootable, a default partition in the disk set by the BIOS is read.

9. The selectable booting operation method by the BIOS with the multi-partition in the disk of claim 8, wherein when the default partition is bootable, a boot sector in the default partition is read so as to boot the computer.

10. The selectable booting operation method by the BIOS with the multi-partition in the disk of claim 8, wherein when the default partition is not bootable, a boot fail message is displayed.

11. The selectable booting operation method by the BIOS with the multi-partition in the disk of claim 1, wherein the interrupt service program is an INT 1 9H interrupt service program.
